(19) United States
(12) Patent Application Publication
(10) Pub. No.: US 2026/0288858 A1
(43) Pub. Date: Sep. 24, 2026

(54) PROVISION OF TOPICS FOR INCOMING COMMUNICATIONS

(71) Applicant: Lenovo Global Technology (United States) Inc., Morrisville, NC (US)

(72) Inventors: Nathan Peterson, Oxford, NC (US); Mark Delaney, Raleigh, NC (US); Diana Gerli, Raleigh, NC (US); John C. Mese, Cary, NC (US)

(21) Appl. No.: 19/084,326

(22) Filed: Mar. 19, 2025

(51) Int. Cl. G06F 16/51; G06F 16/55

(52) U.S. Cl. CPC G06F 16/51; G06F 16/55

(57) ABSTRACT

One embodiment provides a method, the method including: obtaining, using a recall assistance system of a communication device, information associated with previous interactions between a user of the communication device and a stored contact of the user; detecting, using the recall assistance system, an incoming communication from the stored contact of the user; and transmitting, using the recall assistance system and upon the detecting of the incoming communication, instructions to display, on a display device of the communication device and concurrently with an indication of the incoming communication, generated recollection content related to at least one topic identified from the previous interactions between the user and the stored contact and identified as having a relevancy to the contact and the user. Other aspects are claimed and described.

### BACKGROUND

People have many different contacts across many different platforms and/or communication mediums. For example, people may have contacts across social media platforms, text messaging applications, video conferencing applications, traditional calling applications, and/or the like. Additionally, people may have different contacts for different settings or different relationships with contacts. For example, people may be connected to others for work, as family, due to different associations (e.g., school, clubs, groups, etc.), as friends, due to business relationships, and/or the like. Due to all of these communication mediums, settings, and relationships, people can have a very large number of contacts. Depending on the relationship, people may communicate with different contacts at different frequencies. For example, a person may communicate with a family member more frequently than they communicate with a doctor's office. As another example, a person may communicate with a work colleague more frequently during the work week and not as frequently on the weekend.

### BRIEF SUMMARY

In summary, one aspect provides a method, the method including: obtaining, using a recall assistance system of a communication device, information associated with previous interactions between a user of the communication device and a stored contact of the user; detecting, using the recall assistance system, an incoming communication from the stored contact of the user; and transmitting, using the recall assistance system and upon the detecting of the incoming communication, instructions to display, on a display device of the communication device and concurrently with an indication of the incoming communication, generated recollection content related to at least one topic identified from the previous interactions between the user and the stored contact and identified as having a relevancy to the contact and the user.

Another aspect provides a system, the system including: a processor; a memory device that stores instructions that, when executed by the processor, causes the system to: obtain, using a recall assistance system of a communication device, information associated with previous interactions between a user of the communication device and a stored contact of the user; detect, using the recall assistance system, an incoming communication from the stored contact of the user; and transmit, using the recall assistance system and upon the detecting of the incoming communication, instructions to display, on a display device of the communication device and concurrently with an indication of the incoming communication, generated recollection content related to at least one topic identified from the previous interactions between the user and the stored contact and identified as having a relevancy to the contact and the user.

A further aspect provides a product, the product including: a computer-readable storage device that stores executable code that, when executed by a processor, causes the product to: obtain, using a recall assistance system of a communication device, information associated with previous interactions between a user of the communication device and a stored contact of the user; detect, using the recall assistance system, an incoming communication from the stored contact of the user; and transmit, using the recall assistance system and upon the detecting of the incoming communication, instructions to display, on a display device of the communication device and concurrently with an indication of the incoming communication, generated recollection content related to at least one topic identified from the previous interactions between the user and the stored contact and identified as having a relevancy to the contact and the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for displaying content related to a topic that is identified from information of a contact of a user and that is relevant to the relationship between the contact and the user in order to provide the user with information that may be pertinent during an incoming communication from the contact.

FIG. 4 illustrates an example communication overlay having topic information nodes for an incoming communication user.

### DETAILED DESCRIPTION

Due to the large number of contacts that a person may have or communicate with, it can become difficult to keep track of previous conversations, life events, relevant topics, and/or the like, for every contact that may communicate with the person. When a contact initiates a communication with the person, the person may have a moment of panic upon seeing the contacts name and wondering what the contact may want to discuss and whether the person is prepared for a conversation with the contact. For example, if a person receives a phone call from their manager, the person may wonder what the manager may want to discuss during the conversation. The person may also wonder if they will be prepared for the conversation or whether the manager is going to bring up topics that the person is not prepared to discuss. While a person may communicate with some contacts frequently enough to remember the last conversation or to know what the conversation is likely going to be about, it may be particularly difficult to guess the topic for a contact with whom the person is not in frequent communication. Additionally, for some contacts the conversation may not be about specific topics, but rather just a chance to communicate with the person, so it may not be particularly beneficial for the person to figure out what the contact may want to discuss.

Currently, in order to determine what the conversation may be about, the person has to remember about the last conversation or communication that the person had with the contact. In other words, for the person to determine what the conversation might be about, the person has to recall any previous communications. Alternatively, or additionally, the person could access information sources that may include information related to events of the contact. For example, the person could access social media accounts, company profiles or newsletters, and/or the like, to identify possible topics for a conversation with the contact. However, it is impractical to access an information source when a communication is incoming from the contact. In other words, and for example, if the contact is currently calling the person, it is impractical for the person to access information sources before answering the call. Thus, this technique would require the person to keep up-to-date on all the information sources for a contact. While this could potentially be possible for a single contact, this is not practical or even really possible for the multitude of contacts that a person likely has.

Accordingly, the described system and method provides a technique for displaying content related to a topic that is identified from information of a contact of a user and that is relevant to the relationship between the contact and the user in order to provide the user with information that may be pertinent during an incoming communication from the contact. The recall assistance system obtains information for at least one contact of a user. The system may obtain information for all or a subset of the contacts of a user. The system may identify a contact and then obtain information related to that contact. To obtain information, the system may access information sources, for example, social media websites or applications, prior communications, video conferencing applications, text messaging applications, company websites, other websites, other applications, and/or the like. The system may then store and index the information obtained for a contact within a data repository and based upon a user identifier assigned to the contact.

The system may then detect an incoming communication to the person or user. The incoming communication may be associated with a contact of the user. Upon detecting the incoming communication, the system accesses the information corresponding to the contact and that was previously obtained. From the information, the recall assistance system is able to create content related to at least one topic identified from the information. The topic is identified as having a relevancy to a relationship between the user and the contact. To identify a relevancy, the system may assign a relevancy score to different topics that have been identified from the information and based upon the relationship. Higher scores may identify a higher relevancy to the user and the contact. In addition to assigning a relevancy score, the system may also identify a recall score that corresponds to a recall capability which identifies how easily the user can recall the information based upon the content that can be displayed to the user. Topics having higher relevancy scores and/or recall scores may be ranked higher.

Once some topics are identified, the system generates content from the topics to be displayed on a display screen. The content may be displayed as an add-in to a communication application or may be presented as an overlay over the communication application. The content is displayed as the communication notification is incoming, meaning it is displayed with the incoming communication notifications. Accordingly, the system may transmit instructions to display the content on a display device. Thus, the user can be provided with content that may provide an idea of what the contact may want to discuss in real-time with the incoming communication notification.

Therefore, a system provides a technical improvement over traditional methods for presenting incoming communication information. Instead of simply providing a notification that a communication is incoming, the system also provides information related to topics that the contact might attempt to discuss with the person receiving the incoming communication. This provides the person who is receiving the communication with some ideas regarding topics that the contact may attempt to discuss, so the person can determine if they are prepared to discuss the topic. Additionally, the provision of topics can also include a provision of additional information related to the topic which may assist the person in communicating about the topic if the contact attempts to discuss that topic. Thus, instead of a person having to manually recall information related to a particular contact, the system is able to provide this information so that the person can be prepared for a discussion regarding different topics. Additionally, since the system is able to pull information from information sources, the person can also be apprised of events related to the contact which reduces the need for the person to keep track of events for all possible contacts.

Accordingly, the system provides a technique for informing a person of information related to a contact that allows the person to be more prepared for a communication conversation with a contact as compared to traditional techniques. Additionally, the system provides for a user-friendly interface regarding the provision of the information which is not provided using traditional techniques. Finally, the system also provides the information at the time that a communication is incoming so that the person can be apprised of the information at a time when it would be needed, instead of relying on a person to periodically obtain information related to a multitude of contacts that a person may have.

The illustrated example embodiments will be best understood by reference to the figures. The following description is intended only by way of example, and simply illustrates certain example embodiments.

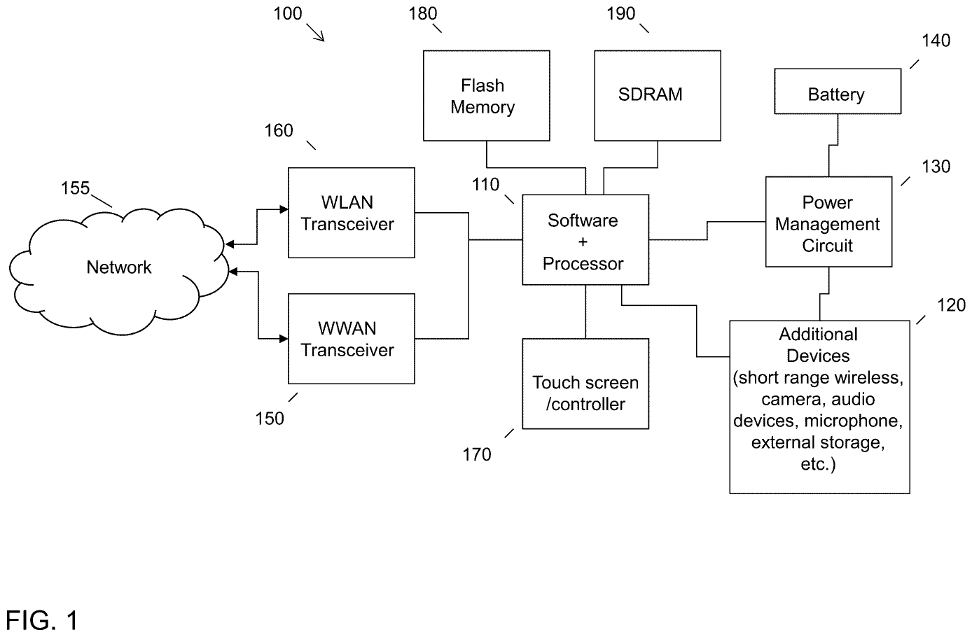

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

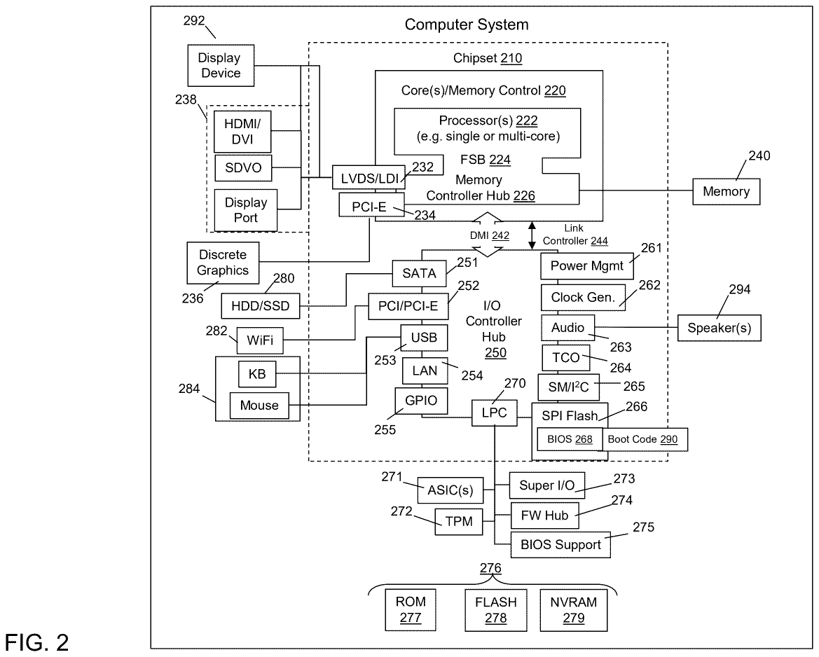

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices that are used to by users to receive incoming communications, that house or provide access to the recall assistance system, and/or the like. For example, the circuitry outlined in FIG. 1 may be implemented in a tablet or smart phone embodiment, whereas the circuitry outlined in FIG. 2 may be implemented in a personal computer embodiment.

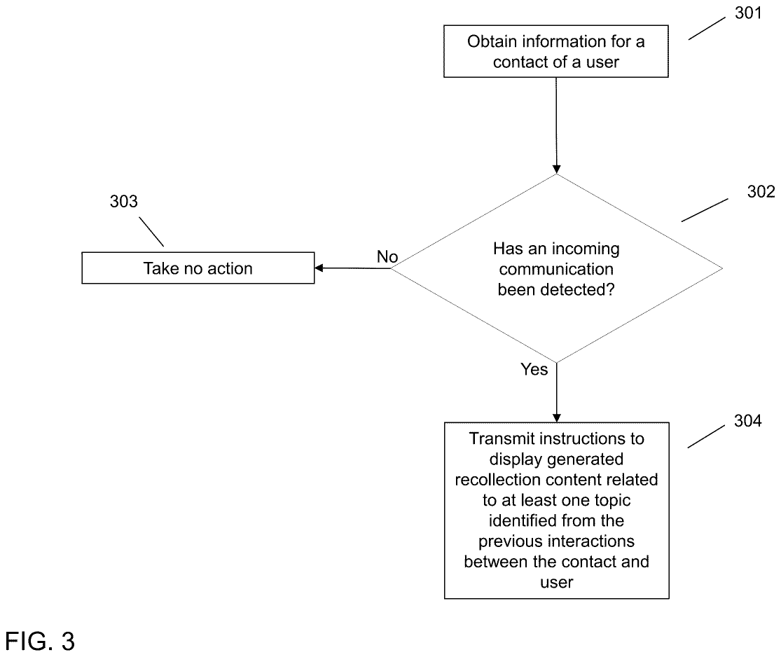

FIG. 3 illustrates an example method for displaying content related to a topic that is identified from information of a contact of a user and that is relevant to the relationship between the contact and the user in order to provide the user with information that may be pertinent during an incoming communication from the contact. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to provide topics to a user who is receiving an incoming communication from a contact. Additionally, the recall assistance system includes modules and features that are unique to the described system.

The recall assistance system may be activated in order to provide content related to a contact to be displayed upon detection of an incoming communication or incoming communication notification. Thus, the recall assistance system may be activated upon detection of an incoming communication notification at one or more devices of a user. Additionally, the recall assistance system may be activated when information for contacts needs to be obtained. Thus, the recall assistance system may be activated at a predetermined and/or reoccurring frequency to obtain the information for contacts at a predetermined frequency. Upon activation of the recall assistance system, information for contacts can be obtained and content related to topics that are relevant to the user and contact can be created and displayed upon detection of an incoming communication or incoming communication notification. Upon creation of the content, the system can transmit instructions to display the content.

Activation of the recall assistance system may be a manual activation of the recall assistance system and/or an automatic activation of the recall assistance system. Manual activation of the system may include a user opening an application associated with the recall assistance system, the user accessing the computing system associated with the recall assistance system, and/or the user otherwise providing input to the recall assistance system. The automatic activation of the recall assistance system may be based upon the detection of a trigger event indicating that the system should be activated. Example trigger events include the user receiving an incoming communication notification, a user adding or updating a contact within an application or program that allows for the storage of contacts, a user accessing an application that interfaces with the recall assistance system, activation of software or an application utilizing the recall assistance system, and/or the like.

The recall assistance system may be made of multiple systems or modules that communicate together to make up the recall assistance system or may be a single system. The recall assistance system may be a standalone system, may be accessible through other computing devices, and/or a combination thereof. For example, the recall assistance system may be a standalone system that can be accessed by a user and/or may be or provide an application that is accessible by a user on another computing device. The recall assistance system may be accessible using any type of computing device, for example, personal computer, laptop computer, smartphone, tablet, smartwatch, head-mounted display, smart television or other smart appliance, augmented reality device, virtual reality device, and/or the like.

Thus, the recall assistance system may be accessible locally using a computing device where the recall assistance system is installed and/or may be accessible remotely through another computing device. For example, the recall assistance system may be accessed by a user using a device that communicates with the recall assistance system to add or update contacts within communication applications that are accessible to or accessible by the recall assistance system, to change preferences regarding when information for contacts should be obtained or updated, to access a data repository where information related to contacts is stored, and/or the like. However, the recall assistance system may be located and operate on a different information handling device to perform the described steps. In other words, the user may access a device housing the recall assistance system or may access a device that communicates with a device housing the recall assistance system.

The recall assistance system can be provided as a service to other entities or companies. In other words, the recall assistance system could be stored on a server or network of a company and the system could obtain information for contacts of a user, store the information for the contacts of a user, and generate content to be displayed on a user device for other companies or entities, with the other companies or entities paying for the provision of the content or use of the recall assistance system. For example, a company or user may allow the service provider access to contact information so that the service provider could obtain information for the contacts and generate content to be displayed in response to an incoming communication. Thus, the service provider could provide the actual obtaining of the information, generating of content for display, transmitting of instructions to display the content, and/or the like.

The recall assistance system may have an associated graphical user interface. The recall assistance system may also display a graphical user interface. The description of the graphical user interface here is a description of a graphical user interface that can be used by a user to adjust the recall assistance system, provide input to the recall assistance system, and/or the like, and not the graphical user interface that is displayed by the recall assistance system in response to detecting an incoming communication or incoming communication notification. The graphical user interface may be provided on a display or monitor, which may or may not be associated with the recall assistance system. In other words, the recall assistance system may have a dedicated display or monitor or may be accessible using any display or monitor. In either case, the recall assistance system may provide instructions to generate and display the graphical user interface on the display device being used to access the recall assistance system. The graphical user interface may also be updated and managed based upon instructions provided by the recall assistance system. In other words, the recall assistance system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the recall assistance system. For example, the recall assistance system may utilize a user profile, historical information, and/or the like, to identify information that should be obtained for a contact, to identify the contacts for which information should be obtained, to identify how content should be displayed in response to detection of an incoming communication or incoming communication notification, to identify the communication applications or mediums for which content should be provided, to identify how topics should be identified and scored or weighted, and/or the like. The graphical user interface may allow for creation of or access to these profiles, historical information, and/or the like, by allowing a user to input information regarding user preferences, contact information, and/or the like. As will be discussed in more detail, the use of user provided information is not the only way that the profile and/or historical information can be created. The recall assistance system can then utilize these inputs, whether provided directly by the user or identified using a different technique, to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, gaze input, electromyography input, virtual or augmented reality input, and/or the like.

The graphical user interface may also provide displays that display information of the profiles, and/or the like. It should be noted that the information to be used by the recall assistance system and information provided by the recall assistance system can be different for different applications, different computing systems, different users, and/or the like. Thus, the information corresponding to input or output of the recall assistance system are not always the same. However, the recall assistance system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The recall assistance system may utilize one or more artificial intelligence models in obtaining information for contacts and generating content to be displayed on a display with the incoming communication notification. Artificial intelligence models may also be used for steps within a step. For example, a model could be utilized to identify topics within information to generate content to be displayed, determine information sources from which to obtain information related to a contact, determine when or how frequently to obtain information and update information for a contact, and/or the like.

For ease of readability, the majority of the description will refer to a single artificial intelligence model. However, it should be noted that an ensemble of artificial intelligence models or multiple artificial intelligence models may be utilized.

Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model (e.g., a general model, such as a general classification model) that is fine-tuned for the recall assistance system, or the artificial intelligence model may be a model that is created and trained from scratch. Since the recall assistance system is used in conjunction with generating content and displaying the content to a user upon detection of an incoming communication, some models that may be utilized by the system are image analysis models, text analysis models, audio analysis models, analysis models, similarity identification models, language models, large language models, entity identification models, input analysis models, filtering models, classification models, and/or the like. The model may be trained using one or more training datasets.

Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

Whether the model automatically ingests feedback during deployment or not may be determined by a user, author, and/or entity that has deployed the model. Automatic learning by the model may be useful in some applications, but may be detrimental in other applications. Accordingly, a user may make a determination regarding the trainability of the model during deployment. Regardless of whether the model can be retrained during deployment or is only retrained upon instruction by a user, the feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model. Additionally, the feature sets, vectors, layers, outputs, and/or other characteristics of the model may be chosen by a user based upon the application.

The recall assistance system may include different components for carrying out different functions of the system, including different steps to be performed. These components may be hardware components or software components. Some hardware devices or components that may be utilized by the recall assistance system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the recall assistance system. For example, the recall assistance system may include speakers, displays or monitors, haptic output devices, audio output devices, and/or the like.

Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the recall assistance system, and/or the like. The recall assistance system may also interface with hardware components of a device. For example, instead of the recall assistance system including a display, the recall assistance system may provide instructions to display content on a display component of a user device that is employing or communicating with the recall assistance system.

One software component may include a data storage location or data repository that stores information related to contacts, user profiles, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by on-screen graphical element type, grouped by user, grouped by input elements, and/or the like. The data repository may store information related to contacts, for example, the information that is obtained for a particular contact.

In order to efficiently retrieve information related to a contact, the information within the data repository may be stored by contact. In other words, the information within the data repository may be indexed for efficient information retrieval. The information may be stored within the data repository may be indexed based upon an identifier assigned to and corresponding to the contact, based upon a relationship of a contact to the user, and/or the like. Additionally, the information within the data repository may be categorized or grouped, for example, based upon communication medium, based upon a relationship between the contact and the user, based upon a frequency of communication between the contact and the user, based upon categories provided by the user, and/or the like. For example, the system can mine information from information sources, identify a contact corresponding to the information, and then store the information within the data repository based upon the identified contact. To further this example, the contact, and the information corresponding to the contact, may be categorized based upon a relationship of the contact to the user.

The information for a particular contact may also be indexed and/or categorized. For example, information corresponding to a contact may be indexed or categorized based upon a recency of the information, based upon content of the information, based upon a topic of the information, based upon content that has been previously selected by a user in response to an incoming communication from the contact, based upon any preferences set by a user, and/or the like. In determining a topic of the information, the system may employ one or more topic identification techniques, including, but not limited to, entity identification, artificial intelligence models, semantic analysis, syntactic analysis, parts-of-speech analysis, and/or the like.

Another software component includes a user profile that stores information related to a user and user preferences. The user profile may include preferences of a user, information that allows the recall assistance system to identify how often information should be obtained for a contact, from what information sources the information for a contact should be obtained, to identify relationships between contacts and the user, and/or the like. This information may be identified by the user through manual input, or may be identified by the recall assistance system as the user utilizes the system and modifications are made to contacts, content displayed by the system, topics selected by the user, and/or the like. Thus, the recall assistance system can monitor inputs provided by a user at both a device and also at external components. Once the user has provided inputs (e.g., manual input, audible input, gesture input, etc.), the recall assistance system can store this information or settings within the user profile.

The provided inputs may also be inputs that are inferred from other inputs. In other words, the recall assistance system may determine from user movements, facial expressions, gestures, audible input, and/or other inputs, that content needs to be displayed for a particular contact or incoming communication. For example, a user may see an incoming communication notification and may make facial expressions or audible input indicating that the user is wondering what the contact will want to communicate about. The system could then infer from such inputs that the user would benefit from being provided content that could identify potential topics that the contact may want to discuss. Thus, the recall assistance system may monitor a user for inputs other than those inputs provided directly to the recall assistance system. In inferring or correlating inputs, the system may utilize one or more techniques that allows for the inference or identification of information including, but not limited to, rules engines, artificial intelligence models, correlation techniques, and/or the like. These techniques may take the identified information as input, analyze that input based upon the technique programming, and provide an output related to the desired information. This information may then be placed within the user profile for later access.

Any of the mentioned profiles, or other profiles, may include additional information that may be useful for the recall assistance system and may be entered by a user, may be default values, may be learned by the system over time, and/or the like.

Thus, profiles can be populated with information manually by a user, entities or companies, and/or the like, or can be populated over time as the system learns more about the user, models, entities or companies, and/or the like. For example, a user may manually provide input to a user profile and the system can learn preferences about the user over time and populate the user profile with this learned information.

Learned information may be information learned based upon direct inputs, for example, a user may be presented with a pop-up window in response to a trigger and provide input to the pop-up window. This input can be then populated into the user profile. Learned information may also be information learned based upon indirect inputs, for example, a user may provide inputs (e.g., audible inputs, visual inputs, gesture inputs, etc.) that indicate that the user would like to display content for a contact, the user would like to obtain information for a contact, and/or the like. The system can then aggregate this information to learn preferences of the user. Similarly, the system can learn information for other profiles. With respect to the described recall assistance system, the learned information may include historical information, determinations of when information should be obtained for a contact, determinations of a frequency that information should be obtained for a contact or subsets of contacts, the topics for which content should be generated, determinations of relationships between contacts and the user, determinations of relevancy and/or recall scores, and/or the like.

At 301, the recall assistance system, which may be associated with or operatively communicate with a communication device, obtains information for at least one contact of a user. In other words, the recall assistance system obtains information associated with previous interactions between a user of the communication device and a stored contact of the user. As should be understood, this process can be performed for all or a subset of the contacts of a user. However, for ease of readability, the process will be described for a single contact of a user. For more than one contact, the process will be iteratively performed for each of the contacts. The information that may be obtained may be any information related to the contact. Thus, the information may include, but is not limited to, events of the contact (e.g., promotion, birthday, new job, new baby, move, etc.), announcements, news related to the contact, posts by the contact, and/or the like.

To obtain information, the recall assistance system accesses information sources that may contain information related to the contact. Once the information source is identified, the recall assistance system mines the information for a contact from the information source. In other words, the system identifies information pertinent to a contact within the information source and pulls that information from the information source to store in relation to the contact. To identify information pertinent to a particular contact, the system may utilize one or more language processing techniques (e.g., artificial intelligence models, natural language processing techniques, entity identification techniques, etc.), to identify entities within the mined information. Upon identifying entities that correspond to a contact (e.g., contact name, contact phone number, contact user name, contact nickname, other contact identifiers, social media display name, etc.), the system can pull the information related to the text corresponding to the identified entity. The system may store this information as is within the data repository. Alternatively, or additionally, the system can utilize language processing techniques to identify the content or context of the information surrounding the identified entity and store the information with the context. The system can also utilize summarization tools to summarize the information and store the summaries within the data repository.

Different information sources may include, but are not limited to, video conferencing applications, social media applications, email applications, company or entity websites or applications, Internet websites, publicly available sources, and/or the like. To identify the information sources that may contain information related to the contact, the system could be provided with a link, pointer, list of information sources, and/or the like, for the different contacts of the user. For example, when a contact is added for a user, the user could be presented with a graphical user interface requesting the user identify different information sources that can or should be accessed to obtain information for the contact. A similar graphical user interface could also be presented to a contact, where the contact can identify the different information sources that may include information related to the contact. Then when the contact is added as a contact for a user, the identified information sources can be carried over to the user and/or recall assistance system for the user.

The recall assistance system may also identify the information sources for the contacts. One technique for identifying the information sources may be to mine information of the user to determine potential information sources for a contact. As an example, the system may determine that the user communicates with the contact using an email application and social media messaging application. Thus, the system may determine that social media applications or websites may be pertinent to the contact. Accordingly, the system could monitor applications and programs of the user to determine pertinent information sources for a contact. To determine the pertinent information sources, the system can monitor the applications and programs and mine information from the applications and programs. With the mined information, the system can utilize language processing techniques (e.g., artificial intelligence models, natural language processing techniques, entity identification techniques, etc.), to identify entities within the mined information. Upon identifying entities that correspond to a contact (e.g., contact name, contact phone number, contact user name, contact nickname, other contact identifiers, etc.), the system can identify if there are other entities or content that can be correlated to an information source. As an example, if a name of a contact is found within an email related to a social media application, the system could determine that the social media application may be an information source for that contact.

Another technique for the recall assistance system to identify the information sources may be based upon a relationship between the user and the contact. For example, if the relationship between the user and a contact is a work relationship, the system may identify that information sources associated with the company for which the user and contact work may be pertinent to the contact. Thus, the relationship between the user and the contact may provide some insight to pertinent information sources for the contact. To identify a relationship between the user and the contact, the system could request that the user provide this information. The system could also automatically identify the relationship based upon different indicators. For example, if the user only communicates with a contact at a work setting, the system may identify that the contact and user have a work relationship. As another example, the contact information for a contact may provide an indication of a relationship, for example, via the domain of an email address, based upon a phone number of the contact, based upon a user name of the contact within a particular communication medium, and/or the like.

A frequency or time period of communication may also provide an indication of a relationship. For example, communications occurring during work hours may indicate that the relationship is not a social relationship and might be a work relationship, school relationship, or other type of group relationship. As another example, frequent communication may indicate that the user and contact have a more social relationship, even if the user and contact have another relationship, such as a work relationship, school relationship, group relationship, and/or the like.

Other techniques for the recall assistance system to identify the information sources may be based upon other identifiers for a contact, for example, an email address domain, a group or organization associated with the contact, communication mediums (e.g., video conferencing applications, text messaging applications, instant messaging applications, call applications, etc.) associated with the contact, and/or the like. For communication mediums, the system may monitor the communications occurring over the medium and then extract information from the conversations. For example, while a user and contact are conducting a phone conversation, the system may monitor or record the call. The system may create a transcript of the call, but this is not strictly necessary. While monitoring the call or based upon a recording of the call (either a transcript or audio recording), the system can identify topics or content of the conversation. This information can then be saved within the data repository or saved for later obtainment by the recall assistance program.

The information may be obtained for a contact at a predetermined frequency. The predetermined frequency may be set by default, set by a user, learned over time, set for a category of contacts, and/or the like. The frequency at which information is obtained for a contact may be different for each contact, may be different for different categories of contacts (e.g., work contacts, family contacts, group contacts, etc.), may be different based upon a communication frequency between the contact and the user (e.g., a contact whose communication with the user is more frequent may have a more frequent obtainment of information, a contact whose communication with a user meets a particular frequency threshold may have a certain obtainment of information frequency, etc.), may be default values, may be set by a user, may be learned over time, and/or the like. Additionally, the frequency at which information is obtained may vary over time. For example, if a communication frequency between the contact and the user changes, the frequency of obtaining information for the contact may change. As another example, a user may manually change the frequency that information is obtained over time.

Additionally, the information sources that are utilized for obtaining information for a contact may vary between contacts. Some contacts may have corresponding information sources that other contacts do not have, a user may identify that only certain information sources be access for particular contacts, the system may learn that some information sources do not provide information that results in content having a relevancy to the relationship between the user and the contact, a contact may restrict access to certain information sources, and/or the like. Thus, simply because one information source is accessed for one contact, does not mean that same information source can or will be accessed for another contact.

At 302, the recall assistance system may determine if an incoming communication has been detected. The incoming communication may correspond to a stored contact of the user. Depending on the communication medium being utilized, detecting the incoming communication may include detecting an incoming communication notification. In other words, when for some communication mediums, when a communication is incoming, a graphical element will be displayed that indicates the communication is incoming. This graphical element is an incoming communication notification. Detection of this notification may allow the recall assistance system to detect the incoming communication. Thus, the detection of activation of the communication medium to display the notification may also trigger the recall assistance system, thereby allowing the system to detect the incoming communication. For other communication mediums, the communication may simply be displayed without a separate notification. Detection of the graphical user interface having the communication may allow the recall assistance system to detect the incoming communication. Thus, to detect an incoming communication, the recall assistance system may monitor communication mediums and/or communication applications.

The incoming communication may be associated with a contact of the user. In other words, the recall assistance system may determine which contact of the user is connected to the incoming communication. To determine the contact, the system may simply identify that the incoming communication is associated with a contact saved within a device, address book, contacts list, and/or the like, of the user, for example, by analyzing the text included in the incoming communication or incoming communication notification, utilizing language processing techniques, using an artificial intelligence model, and/or the like. In identifying the contact, the system may identify an identifier that is associated with the contact with respect to the data repository. In other words, information contained within the data repository may be indexed by an identifier of contacts. Thus, when the incoming communication is detected, the system identifies the identifier corresponding to that contact that can be used to query the data repository.

If an incoming communication has not been detected at 302, the recall assistance system may take no action at 303. Taking no action may mean that the recall assistance system will not provide instructions to display content. However, the recall assistance system may still run in the background and/or obtain information for contacts at the predetermined frequency. In other words, taking no action at 303 is only with respect to generation and/or provision of content on a display and is not with respect to the entire recall assistance system. Additionally, the system may take no action to display additional content even if an incoming communication is detected. For example, if the system does not have any information related to a contact, the system may not display any content. As another example, a user may identify that for particular contacts content should not be displayed. As a final, non-limiting example, a frequency of communication or a relationship between a user and contact may dictate whether content should be displayed. For example, for a contact with infrequent communication or a long time since the last communication, the system may not display any content.

If, on the other hand, an incoming communication has been detected at 302, the recall assistance system may transmit instructions to display content related to a topic relevant to the contact and the user at 304. In other words, the recall assistance system may transmit, upon detection of the incoming communication, instructions to display on a display device of the communication device, concurrently with an indication of the incoming communication notification, generated recollection content (also referred to as content) related to at least one topic identified from the information, or previous interactions between the user and the stored contact, obtained at 301 for the contact. The at least one topic that is identified is identified as having a relevancy to the contact and the user. For example, the at least one topic may be identified as having a relevancy to a relationship between the contact and the user. The topics included in the data repository may be weighted based upon the relevancy to the relationship between the contact and the user. Topics having a higher weighting may be identified as being more relevant to the relationship as compared to topics having a lower weighting.

The topics within the data repository may be classified into different categories, for example, professional, social, family, life events, achievements, and/or the like. These categories may then be identified as being relevant to the relationship between the contact and the user. For example, for a contact having a work relationship with the user, topics that are categorized as professional may have a higher relevancy as compared to topics categorized as family. Thus, the system may weight the categories with a relevancy based upon the relationship between the contact and the user. Accordingly, topics within categories that having a higher relevancy, may have a higher relevancy score. The system may also score or weight topics individually, regardless of category.

The result is that each topic identified for a contact, contained within a particular category for the contact, included within an identified subset, and/or the like, has a relevancy score. A higher relevancy score indicates that the topic has a higher relevancy to the relationship between the user and contact. Lower relevancy scores indicate that the topic has a lower relevancy to the relationship between the user and contact.

The relevancy score may also have a decay factor that results in the relevancy score decreasing over time. The decay factor may be based upon a time between identification of the topic and detection of the incoming communication. In other words, information having an older date may result in a relevancy score that is lower as compared to the information having a newer date. Additionally, a relevancy score assigned to a topic can decrease over time. However, some relevancy scores may not decrease over time. Whether a relevancy score decreases or decays may be based upon different factors, for example, a type of topic, a reoccurrence or frequency of a topic being obtained within the information, set by a user, default values, and/or the like.

In addition to a relevancy score, the system may also assign a recall score to each of the topics to which a relevancy score was assigned. A recall score may correspond to an ability of the user to recall topics from keywords. In other words, the recall score designates how easy it will be for the user to recall a topic from keywords that may be presented to the user on a display. Thus, the recall score corresponds to the recall capability of the user of the topic utilizing only a few keywords. Topics that would require more keywords or that would be harder to recall from a few keywords would have a lower recall score as compared to topics that could be more easily recalled from a few keywords. The recall score may be a function of how much the topic can be reduced, the complexity of the topic, previous knowledge of the topic by the user, and an amount of time it would take to read the keywords or enough information about the topic to be able to recall the topic. The system may select a topic or topics for which content is to be generated based upon the recall score, where topics having a higher recall score may be more likely to be selected for content generation as compared to topics having a lower recall score.

In selecting a topic for which content is to be generated, the system may aggregate the relevancy score and the recall score for a topic. Aggregating the relevancy score and the recall score may be a simply addition of the two scores, may be an average of the two scores, may include a weighting of one score over the other, and/or the like. How the scores get aggregated may be a default setting, set by a user, be unique for different contacts or groups/categories of contacts, and/or the like. Those topics having higher aggregated scores may be those topics which are selected for content generation.

To generate the content, the system may select the topics based upon the relevancy score, the recall score, the aggregation of the scores, a weighting of topics, and/or the like. The content that is generated includes graphical elements that correspond to the selected topics. The number of topics which are selected for content generation may be default values, may be based upon the communication medium application, may be based upon the device receiving the communication, may be selected by the user, and/or the like. To generate content related to a topic, if it has not already been performed within the data repository, the system may summarize the information related to a particular topic within the data repository. This summary can then be used to generate the content. Within the graphical elements are keywords related to the topic in order to help prompt the user about the topic. Additional information related to a topic may also be provided as a supplemental graphical element. In other words, the primary graphical element may be selectable by the user. If the user selects the graphical element, additional information related to the topic may be displayed in a graphical element.

The content may be displayed in a user interface that is displayed on a display device. The user interface may be an add-in to the communication medium application (e.g., text messaging application, video conferencing application, instant messaging application, social media messaging application, call application, etc.), meaning the recall assistance system results in a modified provision of the communication medium application interface. In such a user interface, the positioning of graphical elements associated with the communication medium application and the positioning of graphical elements associated with the recall assistance system will be such that they do not interfere with each other and still allow for user interaction with any selectable graphical elements.

Alternatively, or additionally, the user interface may be an overlay that is presented on the display of a device. The overlay may be presented over the communication medium application user interface to provide a seamless look to the user interface. Additionally, to allow for user interaction with both the user interface of the recall assistance system and the user interface of the communication medium application, the overlay may be programmed to allow for not only visual transparency at locations not corresponding to graphical elements of the recall assistance system user interface, but may also allow for selection transparency, so that an input provided by a user intended for the underlying graphical user interface (the graphical user interface of the communication medium application) will be detected by the communication medium application.

Additionally, so as to not interfere with user interaction with the underlying graphical user interface, the recall assistance system may detect the location of graphical elements of the underlying graphical user interface on the display device and may position the graphical elements of the recall assistance system graphical user interface so as to not overlay those locations of the underlying graphical user interface graphical elements. In other words, the recall assistance system may take actions so that a user does not detect any interference between the recall assistance system graphical user interface and the graphical user interface of the communication medium application. As can be understood, the location of different graphical elements for the recall assistance system graphical user interface may be different for different communication mediums, for different communication applications on different devices, and/or the like. Thus, the content that is generated and provided for display is displayed at the same time or in real-time when the incoming communication is being detected and/or received.

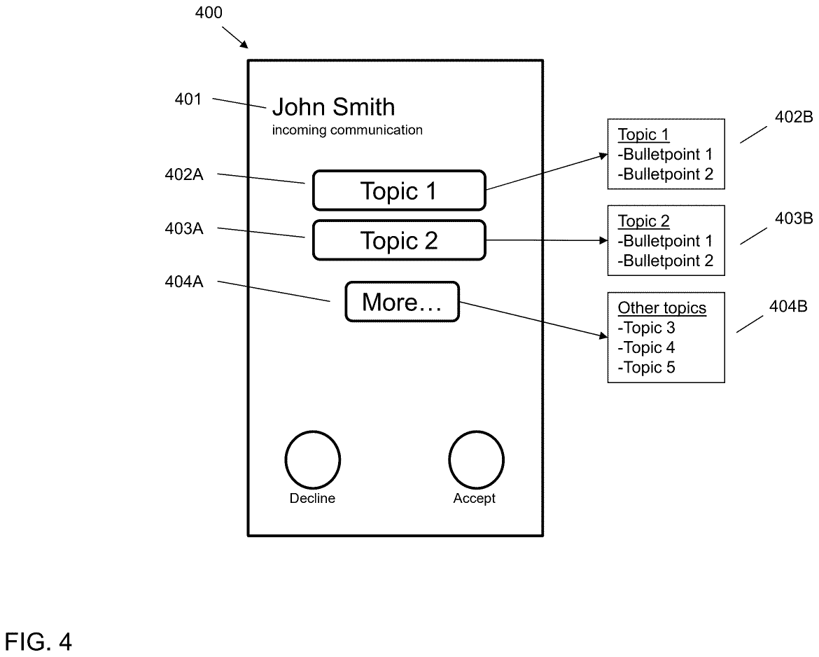

An overall, non-limiting example is illustrated, at least in part, in FIG. 4, which illustrates an example communication overlay having topic information nodes for an incoming communication user. A person who has employed the recall assistance system receives an incoming communication from John Smith 401, which is displayed on a user interface 400 of the device. Upon receiving the incoming communication, the device of the user provides a notification of the incoming communication. The recall assistance system queries the data repository for information related to the contact John Smith 401.

The recall assistance system then provides graphical elements which are selected related to Topic 1 402A and Topic 2 403A. These topics are chosen to be presented based upon a relevancy to a relationship between the user and John Smith.

Additionally, the topics may be further selected for presentation based upon a recall capability of the user with respect to the topic. If the user wants to know more about a particular topic, the user can select the topic icon and be presented with additional information about the topic, for example, as illustrated at 402A and 402B. While these additional information graphical elements are illustrated in FIG. 4 as being off the display, it can be understood that this information would be presented on the display, for example, by replacing the graphical elements 402A and/or 403A, being presented at a different location of the display, and/or the like.

If the user wants to see additional topics that are not presented, the user can provide input to the selectable graphical element related to more topics 404A. Upon selection of this graphical element, the user can be presented with additional topics 404B. For any of these graphical elements, if the user wants even more information, the user may be able to interact with the additional information graphical elements 402B, 403B, and/or 404B to get further information related to a portion of the additional information graphical element 402B, 403B, and/or 404B. Thus, the user can be quickly apprised of topics that the contact may want to discuss. Once the user accepts the communication, the graphical user interface of the recall assistance system may be maintained on the display, may be modified to a different position on the display, may be removed from the display, and/or the like.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, the method comprising:
obtaining, using a recall assistance system of a communication device, information associated with previous interactions between a user of the communication device and a stored contact of the user;
detecting, using the recall assistance system, an incoming communication on the communication device from the stored contact of the user; and
transmitting, using the recall assistance system and upon the detecting of the incoming communication, instructions to display, on a display device of the communication device and concurrently with an indication of the incoming communication, generated recollection content related to at least one topic identified from the previous interactions between the user and the stored contact and identified as having a relevancy to the stored contact and the user.

2. The method of claim 1, wherein the at least one topic selected for display is based upon a weighting of the at least one topic with respect to the at least one contact and the user.

3. The method of claim 1, wherein the topic chosen for display is further based upon a recall capability and an aggregation of a relevancy score corresponding to the relevancy and a recall score corresponding to the recall capability.

4. The method of claim 1, wherein the obtaining of the information comprises accessing an information source and mining the information related to the at least one contact.

5. The method of claim 1, wherein the obtaining of the information comprises storing the information within a data repository and indexing the information to a corresponding of the at least one contact and categorizing the information based upon the relationship between the contact and the user.

6. The method of claim 1, wherein the obtaining of the information comprises obtaining the information at a predetermined frequency for the at least one contact.

7. The method of claim 6, wherein the predetermined frequency changes based upon a frequency of communication between the at least one contact and the user.

8. The method of claim 1, wherein the generated recollection content includes pictorial content.

9. The method of claim 1, wherein the content comprises a selectable icon corresponding to the topic overlaid upon a notification corresponding to the incoming communication.

10. The method of claim 9, wherein, upon receiving input at the selectable icon, additional information corresponding to the topic of the selectable icon is displayed.

11. A system, the system comprising:
a processor;
a memory device that stores instructions that, when executed by the processor, causes the system to:
obtain, using a recall assistance system of a communication device, information associated with previous interactions between a user of the communication device and a stored contact of the user;
detect, using the recall assistance system, an incoming communication on the communication device from the stored contact of the user; and
transmit, using the recall assistance system and upon the detecting of the incoming communication, instructions to display, on a display device of the communication device and concurrently with an indication of the incoming communication, generated recollection content related to at least one topic identified from the previous interactions between the user and the stored contact and identified as having a relevancy to the stored contact and the user.

12. The system of claim 11, wherein the at least one topic selected for display is based upon a weighting of the at least one topic with respect to the at least one contact and the user.

13. The system of claim 11, wherein the topic chosen for display is further based upon a recall capability and an aggregation of a relevancy score corresponding to the relevancy and a recall score corresponding to the recall capability.

14. The system of claim 11, wherein the obtaining of the information comprises accessing an information source and mining the information related to the at least one contact.

15. The system of claim 11, wherein the obtaining of the information comprises storing the information within a data repository and indexing the information to a corresponding of the at least one contact and categorizing the information based upon the relationship between the contact and the user.

16. The system of claim 11, wherein the obtaining of the information comprises obtaining the information at a predetermined frequency for the at least one contact.

17. The system of claim 16, wherein the predetermined frequency changes based upon a frequency of communication between the at least one contact and the user.

18. The system of claim 11, wherein the generated recollection content includes pictorial content.

19. The system of claim 11, wherein the content comprises a selectable icon corresponding to the topic overlaid upon a notification corresponding to the incoming communication; and
wherein, upon receiving input at the selectable icon, additional information corresponding to the topic of the selectable icon is displayed.

20. A product, the product comprising:
a computer-readable storage device that stores executable code that, when executed by a processor, causes the product to:
obtain, using a recall assistance system of a communication device, information associated with previous interactions between a user of the communication device and a stored contact of the user;
detect, using the recall assistance system, an incoming communication on the communication device from the stored contact of the user; and
transmit, using the recall assistance system and upon the detecting of the incoming communication, instructions to display, on a display device of the communication device and concurrently with an indication of the incoming communication, generated recollection content related to at least one topic identified from the previous interactions between the user and the stored contact and identified as having a relevancy to the stored contact and the user.
